(19) United States
(12) Patent Application Publication
(10) Pub. No.: US 2020/0088400 A1
(43) Pub. Date: Mar. 19, 2020

(54) FILL LIGHT APPLIED TO LIVE STREAMING OF MOBILE PHONE

(71) Applicant: Shenzhen Youbaise Technology Co., Ltd., SHENZHEN (CN)

(72) Inventor: Dinglan Li, SHENZHEN (CN)

(73) Assignee: Shenzhen Youbaise Technology Co., Ltd.

(21) Appl. No.: 16/689,109

(22) Filed: Nov. 20, 2019

(51) Int. Cl. F21V 33/00; H04M 1/22; F21V 3/02; F21V 23/04; F21V 17/18; F21V 17/16; F21V 23/06; F21V 23/02

(52) U.S. Cl. CPC F21V 33/0052; H04M 1/22; F21V 3/02; F21V 23/0485; F21W 2131/30; F21V 17/164; F21V 23/06; F21V 23/02; F21V 17/18

(57) ABSTRACT

The present disclosure provides a fill light applied to live streaming of a mobile phone. The fill light applied to live streaming of a mobile phone comprises a shell, a light panel, a light-transmitting cover and a touch pad, the shell comprises a first portion and a second portion, a central portion of the first portion has an opening for accommodating a mobile phone, and the first portion is provided with a mounting groove which is arranged around the opening; the light panel is arranged along the mounting groove; the light-transmitting cover is fixed to the shell and is used for covering the light panel; and the touch pad is arranged at the second portion; wherein switching on and off and/or brightness and/or color temperature of the light panel can be controlled according to a touch signal received by the touch pad.

### TECHNICAL FIELD

The present disclosure relates to a fill light, and in particular to a fill light applied to live streaming of a mobile phone.

### BACKGROUND

A fill light is an accessory for providing light rays in a dim environment. A live streaming stuff needs to use a fill light to light up the body such as the face of a live streamer in order to help the appearance of the live streamer in an obtained live streaming video to be more proper. The existing fill light is independent and is separated from a mobile phone, that is, the fill light is arranged on one side of the mobile phone, so the light filling effect is poor, and the fill light is inconvenient to control.

### SUMMARY

The present disclosure provides a fill light applied to live streaming of a mobile phone, which is beneficial to improving a light filling effect and is convenient to be controlled by a user.

The fill light applied to live streaming of a mobile phone, provided by the present disclosure, comprises:

a shell, comprising a first portion and a second portion, wherein a central portion of the first portion has an opening for accommodating a mobile phone, and the first portion is provided with a mounting groove which is arranged around the opening;

a light panel, arranged along the mounting groove;

a light-transmitting cover, fixed to the shell and used for covering the light panel; and

a touch pad, arranged at the second portion;

wherein switching on and off and/or brightness and/or color temperature of the light panel can be controlled according to a touch signal received by the touch pad.

In use, the mobile phone can be accommodated in the opening of the first portion such that the light panel surrounds the circumference of the mobile phone, and at this time, a camera of the mobile phone is aligned to a position, at which the fill light greatly uniformly fills light, so as to provide filled light uniformity and then to improve a live streaming effect; and the touch pad is arranged at the second portion so that a live streamer can directly touch the touch pad to control the fill light during live streaming, so the control is simpler and quicker.

### BRIEF DESCRIPTION OF THE DRAWINGS

FIG. 1 is a schematic structural diagram of a fill light of an embodiment of the present disclosure.

FIG. 2 is an exploded view of FIG. 1.

### DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure. It can be understood that the accompanying drawings are merely used for providing reference and description, but not limitations to the present disclosure. Connection relationships shown in the accompanying drawings are merely used for facilitating clear description, but are not used to limit connection manners.

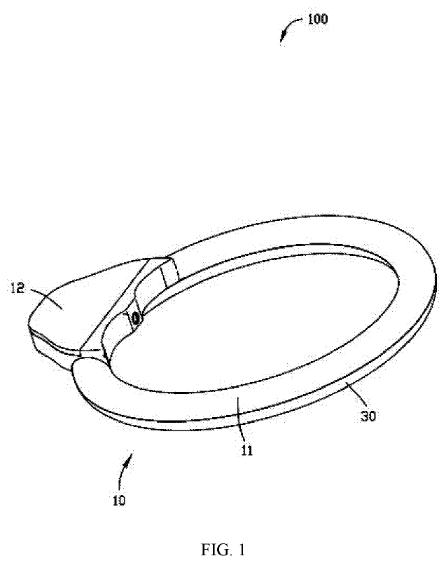

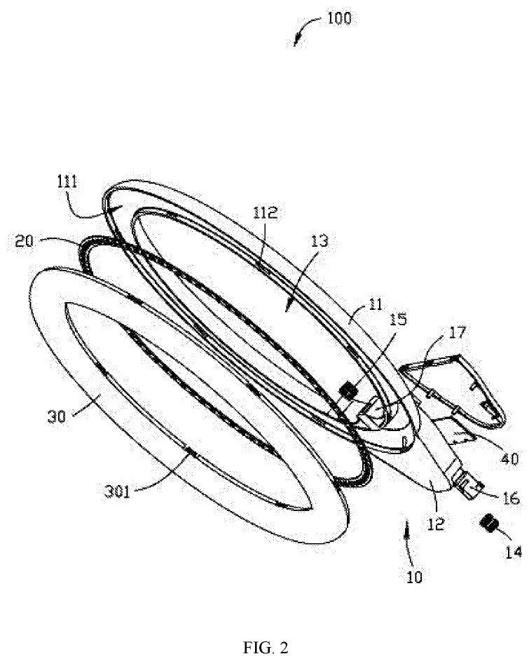

As shown in FIG. 1 and FIG. 2, FIG. 1 is a schematic structural diagram of a fill light 100 of an embodiment of the present disclosure, and FIG. 2 is an exploded view of FIG. 1.

In the embodiment, a fill light 100 comprises a shell 10, a light panel 20, a light-transmitting cover 30 and a control board 40, and the shell 10 comprises a first portion 11 and a second portion 12.

The first portion 11 and the second portion 12 are integrally formed, a central portion of the first portion 11 has an opening 13, and the opening 13 can accommodate a mobile phone.

The first portion 11 is provided with a mounting groove 111 which is arranged around the opening 13. The light panel 20 and the mounting groove 111 have roughly the same shape, the light panel 20 is arranged in the mounting groove 111, and preferably, the light panel 20 is fixed to the second portion 12 through an adhering layer so as to be simple and convenient to mount and also simplify a structure of the light panel 20 and a structure of the shell 10. The light-transmitting cover 30 and the mounting groove 111 also have roughly the same shape, the light-transmitting cover 30 is fixed to the shell 10 so as to cover the light panel 20, and the light-transmitting cover 30 preferably has a light subduing structure to subdue lights emitted by light beads on the light panel 20.

The second portion 12 has a cavity to accommodate the control board 40 therein, the control board 40 and the light panel 20 are electrically connected, and the control on the light panel 20 is achieved by the control board 40. Preferably, the control board 40 can comprise a touch pad, and the touch pad is arranged on the second portion 12 and is used for receiving a touch control signal of a user and controlling switching on and off, and/or brightness and/or color temperature of the light panel 20 according to the touch control signal, for example, the touch pad can dim the light panel 20 in a range of 0%-100% (wherein 0% represents a closing state) and/or can adjust the light panel in a range of 3000 k to 6500 k.

The second portion 12 is located under the first portion 11 and can be provided with a first connector 14, the first connector 14 is located at a lower portion of the second portion 12, the first connector 14 may be a knurled nut and can be used for connecting a support such as a tripod, and through the support, the fill light 100 is lifted up or the height of the fill light 100 is adjusted.

Wherein a power socket 16 or a battery can be mounted in the second portion 12, the power socket 16 can be connected with an external power supply so as to provide power for the light panel 20 and the touch pad, or the battery provides the power for the light panel 20 and the touch pad.

The first portion 11 can be roughly ring-shaped, such as a circular ring or an elliptical ring and the like, so as to be more beneficial to improving the uniformity of light rays. A second connector 15 can be arranged on the first portion 11, similarly the second connector 15 may also be a knurled nut, the second connector 15 can be used for connecting a mobile phone support, and the mobile phone support is used for fixing a mobile phone. Preferably, a protrusion portion 17 extends from the first portion 11 to the opening 13, and the second connector 15 is connected with the protrusion portion 17 such that an edge of the mobile phone is separated from an edge of the opening 13 so as to prevent that light rays of a certain edge are too intense to influence a light filling effect due to the fact that such edge of the mobile phone is too close to the light panel 20. Preferably, a camera of the mobile phone is located at the center of the light panel 20 by configuring a proper structure and height of the protrusion portion 17 so as to improve the light filling effect.

Wherein the first portion 11 is provided with a plurality of first snapping structures 112 arranged along the mounting groove 111, second snapping structures 302 corresponding to the first snapping structures 112 are arranged on the light-transmitting cover 30, and due to matching of the first snapping structure 112 and the second snapping structure 302, the light-transmitting cover 30 is detachably connected with the shell 10. Preferably, the first snapping structure 112 is one of a protruding edge and a snap-in area while the second snapping structure 302 is the other one.

In use, the mobile phone can be arranged in the opening 13 to be roughly in parallel with the shell 10, then the fill light 100 is switched on, wherein the mobile phone is located in the opening 13 of the first portion 11 and is surrounded by the light panel 20 so that light rays emitted by the fill light 100 can irradiate the camera of the mobile phone and the camera is aligned to a position, at which the fill light 100 uniformly fills the light, so a person in a shot video is more attractive.

The above merely describes preferred embodiments of the present disclosure, but are not used to limit the present disclosure. Any modifications, equivalent replacements, improvements and the like within the spirit and principle of the present disclosure shall be all contained in the protection scope of the present disclosure.

What is claimed is:

1. A fill light applied to live streaming of a mobile phone, comprising:
a shell, comprising a first portion and a second portion, wherein a central portion of the first portion has an opening for accommodating a mobile phone, and the first portion is provided with a mounting groove which is arranged around the opening;
a light panel, arranged along the mounting groove;
a light-transmitting cover, fixed to the shell and used for covering the light panel; and
a touch pad, arranged at the second portion;
wherein switching on and off and/or brightness and/or color temperature of the light panel can be controlled according to a touch signal received by the touch pad.

2. The fill light applied to live streaming of a mobile phone according to claim 1, wherein the first portion is roughly ring-shaped.

3. The fill light applied to live streaming of a mobile phone according to claim 2, wherein the second portion is located under the first portion.

4. The fill light applied to live streaming of a mobile phone according to claim 3, wherein a first connector is arranged on the second portion and is used for connecting a support, and the height of the fill light is adjusted by the support.

5. The fill light applied to live streaming of a mobile phone according to claim 4, wherein the first connector is a knurled nut.

6. The fill light applied to live streaming of a mobile phone according to claim 1, wherein a second connector is arranged on the first portion and is used for connecting a mobile phone support, and the mobile phone support is used for fixing a mobile phone to ensure that the mobile phone is accommodated in the opening.

7. The fill light applied to live streaming of a mobile phone according to claim 6, wherein the second connector is a knurled nut.

8. The fill light applied to live streaming of a mobile phone according to claim 6, wherein a protrusion portion extends from the first portion to the opening, and the second connector is connected with the protrusion portion such that an edge of the mobile phone is separated from an edge of the opening.

9. The fill light applied to live streaming of a mobile phone according to claim 7, wherein a protrusion portion extends from the first portion to the opening, and the second connector is connected with the protrusion portion such that an edge of the mobile phone is separated from an edge of the opening.

10. The fill light applied to live streaming of a mobile phone according to claim 1, wherein the first portion is provided with a plurality of first snapping structures arranged along the mounting groove, second snapping structures corresponding to the first snapping structures are arranged on the light-transmitting cover, and due to matching of the first snapping structure and the second snapping structure, the light-transmitting cover is detachably connected with the shell.

11. The fill light applied to live streaming of a mobile phone according to claim 10, wherein the first snapping structure is one of a protruding edge and a snap-in area while the second snapping structure is the other one.

12. The fill light applied to live streaming of a mobile phone according to claim 1, wherein a power socket is arranged on the shell, and the power socket is connected with an external power supply so as to provide power for the light panel and the touch pad.

13. The fill light applied to live streaming of a mobile phone according to claim 12, wherein the power socket is arranged on the second portion.

14. The fill light applied to live streaming of a mobile phone according to claim 1, wherein a battery is arranged in the second portion, and the battery provides power for the light panel and the touch pad.

15. The fill light applied to live streaming of a mobile phone according to claim 1, wherein the light panel is fixed to the second portion through an adhering layer.
